(19) United States
(12) Patent Application Publication
(10) Pub. No.: US 2005/0099690 A1
(43) Pub. Date: May 12, 2005

(54) Washing device for washing the transparent layer of the image sensor package

(76) Inventor: Reg Yang, Hsinchu Hsien (TW)

Correspondence Address: Keith Kline;PRO-TECHTOR INTERNATIONAL, 20775 Norada Court, Saratoga, CA, 95070-3018, US

(21) Appl. No.: 10/705,387

(22) Filed: Nov. 10, 2003

(51) Int. Cl. G02B 1/00

(52) U.S. Cl. 359/507; 359/509

(57) ABSTRACT

A mechanism for cleaning a transparent layer of an image sensor, the transparent layer has an upper surface and a lower surface, the mechanism includes a transport device for transporting the transparent layer. A first positioned device is arranged under the transport device to position the lower surface of the transparent layer. A first cleaning device is arranged onto the transport device for cleaning the upper surface of the transparent layer. A second positioned device is arranged onto the transport device to position the upper surface of the transparent layer. A second cleaning device is arranged under the transport device for cleaning the lower surface of the transparent layer, respectively, to clean the transparent layer.

### BACKGROUND OF THE INVENTION

1. Field of the invention

The invention relates to a mechanism for cleaning a transparent layer of an image sensor, and in particular to a mechanism for efficiently and quickly cleaning a transparent layer, so as to increase the production yield.

2. Description of the Related Art

Referring to FIG. 1, a conventional image sensor includes a substrate 10, a frame layer 18, a photosensitive chip 26, a plurality of wires 28, and a transparent layer 34. The substrate 10 has a first surface 12 on which a plurality of signal input terminals 15 is formed, and a second surface 14 on which a plurality of signal output terminals 16 is formed. The frame layer 18 has an upper surface 20 and a lower surface 22 adhered to the first surface 12 of the substrate 10 to form a chamber 24 together with the substrate 10. The photosensitive chip 26 is arranged within the chamber 24 and is mounted to the first surface 12 of the substrate 10. Each wire 28 has a first terminal 30 and a second terminal 32. The first terminals 30 are electrically connected to the photosensitive chip 26, and the second terminals 32 are electrically connected to the signal input terminals 15 of the substrate 10. The transparent layer 34 is adhered to the upper surface 20 of the frame layer 18.

In order to finish the above-mentioned package processes, the transparent

In order to finish the above-mentioned package processes, the transparent layer34 10 has to be efficiently cleaned, so as to decrease the particle. Then the tradition method of cleaning the transparent layer is by operator myself cleaning. Thus it is difficult to quickly clean the transparent layer and the cleaning quality can not efficiently control. Therefore, the quality of the image sensor is influenced.

### SUMMARY OF THE INVENTION

An object of the invention is to provide a mechanism for cleaning a transparent layer of an image sensor, wherein the transparent layer may be cleaned and quickly cleaning a transparent layer, so as to increase the production yield.

To achieve the above-mentioned object, the invention provides a mechanism for cleaning a transparent layer of an image sensor, the transparent layer having an upper surface and a lower surface, the mechanism includes a transport device for transporting the transparent layer. A first positioned device is arranged under the transport device to position the lower surface of the transparent layer. A first cleaning device is arranged onto the transport device for cleaning the upper surface of the transparent layer. A second positioned device is arranged onto the transport device to position the upper surface of the transparent layer. A second cleaning device is arranged under the transport device for cleaning the lower surface of the transparent layer.

### BRIEF DESCRIPTION OF THE DRAWINGS

FIG. 1 is a cross-sectional view showing a conventional image sensor.

FIG. 2 is a first schematic illustration showing a mechanism for cleaning a transparent layer of an image sensor of the present invention.

FIG. 3 is a second schematic illustration showing a mechanism for cleaning a transparent layer of an image sensor of the present invention..

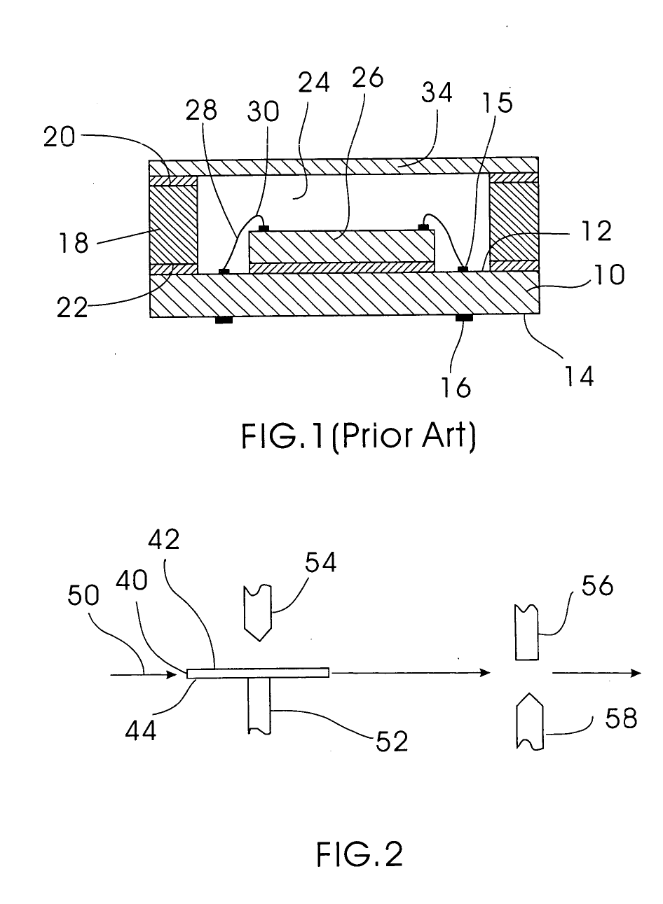

### DETAILED DESCRIPTION OF THE INVENTION

Please refer to FIG. 2. A mechanism for cleaning a transparent layer of an image sensor of the present invention includes a transport device50, a first positioned device52, a first cleaning device54, a second positioned device56, and a second cleaning device58. Wherein the transparent layer40 has a upper surface 42 and a lower surface44.

The transport device50 is for transporting the transparent layer40.

The first positioned device52 is arranged under the transport device50, while the transparent layer40 is arranged on the transport device50, the first positioned device50 is attracted the lower surface44 of the transparent layer40 by a vacuum pump to position the lower surface44 of the transparent layer40.

The first cleaning device54 is a water knife, is arranged onto the transport device50, while the first positioned device52 attracted the transparent layer40, the first cleaning device54 cleaned the transparent layer40 by water.

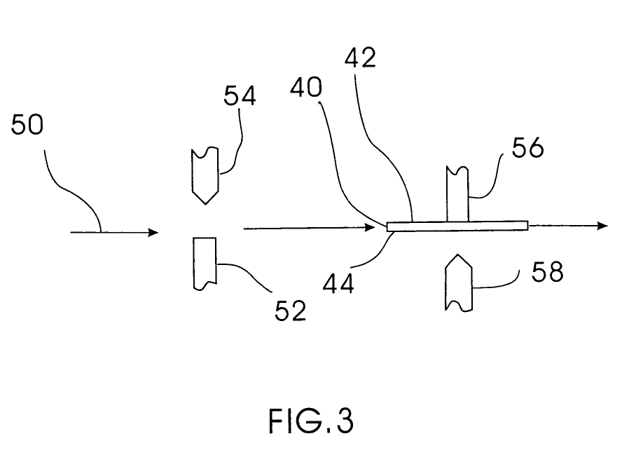

Please refer to FIG.3. The second positioned device56 is arranged onto the transport device50 to attract the upper surface42 of the transparent layer40 by a vacuum pump.

The second cleaning device58 is a water knife, is arranged under the transport device50 for cleaning the lower surface44 of the transparent layer40 by water.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

1. A mechanism for cleaning a transparent layer of an image sensor, the transparent layer having an upper surface and a lower surface, the mechanism comprising:
a transport device being for transporting the transparent layer;
a first positioned device arranged under the transport device to position the lower surface of the transparent layer;
a first cleaning device being arranged onto the transport device for cleaning the upper surface of the transparent layer;
a second positioned device being arranged onto the transport device to position the upper surface of the transparent layer; and
a second cleaning device arranged under the transport device for cleaning the lower surface of the transparent layer.

2. The mechanism according to claim 1, wherein the first positioned device is a vacuum pump for attracting the lower surface of the transparent layer.

3. The mechanism according to claim 1, wherein the first cleaning device is a water knife.

4. The mechanism according to claim 1, wherein the second position device is a vacuum pump for attracting the upper surface of the transparent layer.

5. The mechanism according to claim 4, wherein second cleaning device is a water knife. 5/5 KT156A water knife. 6/6
